(19) United States
(12) Patent Application Publication
(10) Pub. No.: US 2024/0127333 A1
(43) Pub. Date: Apr. 18, 2024

(54) Transaction Method, Apparatus, Device, and System

(71) Applicant: Shanghai Weilian Information Technology Co., Ltd., Shanghai (CN)

(72) Inventor: Jianliang GU, Shanghai (CN)

(21) Appl. No.: 17/768,691

(22) PCT Filed: Oct. 29, 2020
(86) PCT No.: PCT/CN2020/124911

§ 371 Date: Apr. 13, 2022

(30) Foreign Application Priority Data
Oct. 30, 2019 (CN) 201911046894.7

(51) Int. Cl. G06Q 40/04; G06Q 20/10; H04L 9/00

(52) U.S. Cl. CPC G06Q 40/04; G06Q 20/10; H04L 9/50

(57) ABSTRACT

Methods, apparatuses, devices, and systems for facilitating enterprise-to-enterprise financial transactions in a supply chain. In an example, the method includes: receiving, by a management server, a virtual currency transfer request from a first device, wherein the virtual currency transfer request includes a first amount of a to-be-transferred virtual currency and an identifier of a second device; and transferring, by the management server in response to the virtual currency transfer request, the virtual currency of the first amount belonging to the first device to the second device corresponding to the identifier of the second device. The transferred virtual currency may be used to be exchanged for a legal currency. In this example delivery is performed based on a virtual currency, and when an enterprise in the supply chain needs to obtain funds, a virtual currency belonging to that enterprise can be exchanged for a legal currency at any time.

### TECHNICAL FIELD

This application relates to the field of transaction technologies, and in particular, to a transaction method, apparatus, device, and system.

### BACKGROUND

In the process of supply chain management of enterprises, goods, information, and funds may generally be circulated between different enterprises. The circulation of goods and information between different enterprises is generally smooth. However, in practical application, the flow of funds between different enterprises generally has a certain lag. For example, in an actual application, in order to make clearing easy, a manufacturer may choose to settle the goods regularly and pay corresponding funds to a supplier. For example, although the supplier supplies the goods to the manufacturer many times in a quarter, the manufacturer may choose to clear in one go at the end of the quarter and pay the supplier for all the goods supplied during the quarter. Therefore, the funds transferred from the manufacturer to the supplier may have a lag of a quarter.

It is understandable that the lag of the flow of funds may have a certain impact on capital chains of some enterprises (such as enterprises that supply goods or provide services in a supply chain), so that the enterprises cannot get required funds in real time. For example, when the capital chain of the supplier does not operate smoothly, based on an existing transaction method, the supplier may not be able to timely obtain funds corresponding to currently provided goods to alleviate the current fund shortage. Therefore, some enterprises in the existing transaction method may not be able to timely get the funds they should obtain from other enterprises.

### SUMMARY OF THE DISCLOSURE

A transaction method, apparatus, device, and system are provided in embodiments of this application, so that some enterprises in a supply chain can get, at any time, the funds they should obtain.

In a first aspect, the embodiments of this application provide a transaction method, including:
receiving a virtual currency transfer request from a first device, the virtual currency transfer request including a first amount of a to-be-transferred virtual currency and an identifier of a second device; and
transferring, in response to the virtual currency transfer request, the virtual currency of the first amount belonging to the first device to the second device corresponding to the identifier of the second device,
wherein the virtual currency is used to be exchanged for a legal currency.

In some possible implementations, the method further includes:
receiving a virtual currency exchange request from the second device, the virtual currency exchange request including a second amount of a to-be-exchanged virtual currency; and
exchanging for the legal currency corresponding to the virtual currency of the second amount to a target device, wherein the target device is a device that provides legal currency support.

In some possible implementations, the method further includes:
destroying the virtual currency of the second amount.

In some possible implementations, the method further includes:
receiving a legal currency exchange request, the legal currency exchange request including a third amount of a to-be-exchanged legal currency; and
exchanging for a virtual currency corresponding to the legal currency of the third amount to a target device, wherein the target device is a device that provides legal currency support.

In some possible implementations, the transferring the virtual currency of the first amount belonging to the first device to the second device corresponding to the identifier of the second device includes:
verifying a virtual currency transfer permission of the first device; and
transferring, if the virtual currency transfer permission succeeds in the verification, the virtual currency of the first amount belonging to the first device to the second device corresponding to the identifier of the second device.

In some possible implementations, the method further includes:
allocating data uploaded by the first device and/or the second device to a target node in a blockchain.

In some possible implementations, the first device belongs to a goods demander, the second device belongs to a goods supplier, and the first amount of the virtual currency is determined according to goods data of goods supplied by the goods supplier to the goods demander.

In a second aspect, the embodiments of this application further provide a transaction apparatus. The apparatus is applied to a management server, and the apparatus includes:
a first receiving module configured to receive a virtual currency transfer request from a first device, the virtual currency transfer request including a first amount of a to-be-transferred virtual currency and an identifier of a second device; and
a transfer module configured to transfer, in response to the virtual currency transfer request, the virtual currency of the first amount belonging to the first device to the second device corresponding to the identifier of the second device,
wherein the virtual currency is used to be exchanged for a legal currency.

In some possible implementations, the apparatus further includes:
a second receiving module configured to receive a virtual currency exchange request from the second device, the virtual currency exchange request including a second amount of a to-be-exchanged virtual currency; and
a first exchange module configured to exchange for the legal currency corresponding to the virtual currency of the second amount to a target device, wherein the target device is a device that provides legal currency support.

In some possible implementations, the apparatus further includes:
a destruction module configured to destroy the virtual currency of the second amount.

In some possible implementations, the apparatus further includes:
a third receiving module configured to receive a legal currency exchange request, the legal currency exchange request including a third amount of a to-be-exchanged legal currency; and
a second exchange module configured to exchange for a virtual currency corresponding to the legal currency of the third amount to a target device, wherein the target device is a device that provides legal currency support.

In some possible implementations, the transfer module includes:
a verification unit configured to verify a virtual currency transfer permission of the first device; and
a transfer unit configured to transfer, if the virtual currency transfer permission succeeds in the verification, the virtual currency of the first amount belonging to the first device to the second device corresponding to the identifier of the second device.

In some possible implementations, the apparatus further includes:
an allocation module configured to allocate data uploaded by the first device and/or the second device to a target node in a blockchain.

In a third aspect, the embodiments of this application further provide a device including a memory and a processor;
the memory is configured to store a computer program; and
the processor is configured to perform the transaction method in any one of the items in the first aspect according to the computer program.

In a fourth aspect, the embodiments of this application further provide a transaction system. The system includes the first device, the second device, the management server, and the target device described in the first aspect.

In the foregoing implementations of the embodiments of this application, a management server may receive a virtual currency transfer request from a first device, wherein the virtual currency transfer request may include a first amount of a to-be-transferred virtual currency and an identifier of a second device, and then the management server may transfer, in response to the received virtual currency transfer request, the virtual currency of the first amount belonging to the first device to the second device corresponding to the identifier of the second device. It is worth noting that the transferred virtual currency may be used to be exchanged for a legal currency. As can be seen, in a transaction process, the management server may transfer the virtual currency belonging to the first device to the second device, that is, the delivery is performed based on a virtual currency in the transaction process. In this way, when an enterprise to which a second device in a supply chain belongs needs to obtain funds, a virtual currency belonging to the second device can be exchanged for a legal currency, so that the enterprise can get the required legal currency at any time by means of currency exchange. Moreover, the delivery is performed based on a virtual currency in the transaction process, which does not require capital transfer, and may effectively reduce due diligence costs of the funding parties.

### BRIEF DESCRIPTION OF THE DRAWINGS

In order to more clearly describe the technical solutions in the embodiments of this application, the accompanying drawings needing to be used in the description of the embodiments will be briefly introduced below. It is apparent that the accompanying drawings in the following description are merely some embodiments recited in this application. For those of ordinary skill in the art, other accompanying drawings may also be obtained according to these accompanying drawings.

FIG. 1 is a schematic framework diagram of an example transaction system involved in an application scenario according to an embodiment of this application;

FIG. 2 is a schematic flowchart of an example transaction method according to an embodiment of this application;

FIG. 3 is a schematic structural diagram of an example transaction apparatus according to an embodiment of this application; and

FIG. 4 is a schematic diagram of a hardware structure of an example device according to an embodiment of this application.

### DETAILED DESCRIPTION

In actual applications, some enterprises may not be able to timely get corresponding funds after providing services or supplying goods to other enterprises. For example, enterprise A that is supplied with goods or provided with services may pay funds on a regular basis (such as 3 months or 6 months) to enterprise B that provides the goods or services. As a result, after enterprise B provided goods or services for enterprise A in January, enterprise A may pay corresponding funds to enterprise B in March or June, so that enterprise B cannot obtain the funds in real time. Especially when enterprise B is in shortage of funds, enterprise B may not be able to get the funds to alleviate the current fund shortage.

For this reason, a transaction method is provided in embodiments of this application, so that some enterprises in a supply chain can receive, at any time, the funds they are due. Specifically, the method may be applied to a management server, and the management server may receive a virtual currency transfer request from a first device (belonging to one part of the enterprises in the supply chain), wherein the virtual currency transfer request may include a first amount of a to-be-transferred virtual currency and an identifier of a second device (that is, a virtual currency transfer object, belonging to the other part of the enterprises in the supply chain). Then, the management server may transfer, in response to the received virtual currency transfer request, the virtual currency of the first amount belonging to the first device to the second device corresponding to the identifier of the second device. It is worth noting that the transferred virtual currency may be used to be exchanged for a legal currency.

As can be seen, in a transaction process, the management server may transfer the virtual currency belonging to the first device to the second device, that is, the delivery is performed based on a virtual currency in the transaction process. In this way, when an enterprise to which a second device in a supply chain belongs needs to obtain funds, a virtual currency belonging to the second device can be exchanged for a legal currency, so that the enterprise can get the required legal currency at any time by means of currency exchange. Moreover, the delivery is performed based on a virtual currency in the transaction process, which does not require capital transfer, and may effectively reduce due diligence costs of the funding parties.

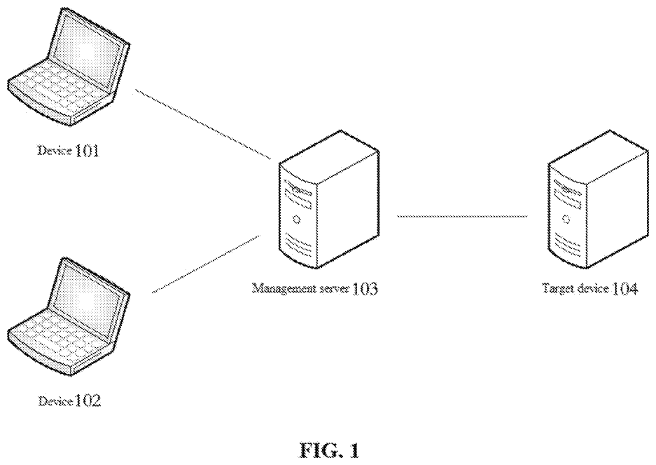

As an example, the embodiment of this application may be applied to the transaction system as shown in FIG. 1. As shown in FIG. 1, the transaction system may include device 101, device 102, management server 103, and target device 104. Device 101 may belong to a supplier, and device 102 may belong to a distributor. When the distributor receives goods supplied by the supplier, the distributor may use device 102 to pay corresponding virtual currency to the supplier. In a specific implementation, device 102 may generate a virtual currency transfer request for the batch of goods. The virtual currency transfer request carries at least an amount of a to-be-transferred virtual currency and an identifier of a virtual currency transfer object, i.e., device 101. Then, device 102 may send the virtual currency transfer request to management server 103 to request management server 103 to complete transfer of the virtual currency. Management server 103 may determine, in response to the received virtual currency transfer request, the amount of the to-be-transferred virtual currency, and transfer the virtual currency of the amount belonging to device 102 to device 101 according to the identifier of device 101, so that device 101 can obtain the increased virtual currency of the amount. When the supplier needs to obtain funds, it may use management server 103 to exchange the corresponding virtual currency for a legal currency to the target device.

It is understandable that the transaction system shown above is only a scenario example according to an embodiment of this application, and the embodiment of this application is not limited to the scenario. For example, in other possible implementations, the transaction system may further include other devices, such as a device belonging to a manufacturer and a device belonging to a retailer. When the supplier provides goods to the manufacturer and the retailer, the device of the manufacturer or the device of the retailer may also request transfer of the corresponding virtual currency to device 101 or the like. In short, the embodiment of this application may be applied to any applicable application scenarios, and is not limited to the foregoing scenario examples.

In order to make the foregoing objectives, features, and advantages of this application more apparent and understandable, various non-limiting implementations in the embodiments of this application will be exemplified below with reference to the accompanying drawings. Obviously, the described embodiments are part of the embodiments of this application, rather than all of the embodiments. Based on the embodiments in this application, all other embodiments obtained by those of ordinary skill in the art without creative efforts are all encompassed in the protection scope of this application.

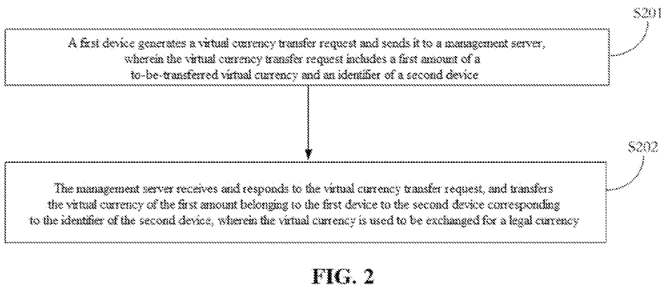

Referring to FIG. 2, FIG. 2 is a schematic flowchart of a transaction method according to an embodiment of this application. In this embodiment, the technical solution in the embodiment of this application is described in detail by multi-party interaction. The method may specifically include the following steps.

In S201, a first device generates a virtual currency transfer request and sends it to a management server, wherein the virtual currency transfer request includes a first amount of a to-be-transferred virtual currency and an identifier of a second device.

In this embodiment, the first device and the second device may belong to different enterprises. It is assumed that the first device belongs to enterprise A and the second device belongs to enterprise B. When enterprise B supplies goods or provides services for enterprise A, enterprise A may pay corresponding virtual currency to enterprise B through the first device to complete the delivery of the supplied goods or provided services.

In a specific implementation, the first device may generate a virtual currency transfer request and send the virtual currency transfer request to the management server, to request the management server to transfer a certain amount of virtual currency to the second device. The generated virtual currency transfer request may include an amount (hereinafter referred to as a first amount) of a to-be-transferred virtual currency to indicate the management server of a specific amount of the transferred virtual currency. The first amount may be entered by a user to the first device. At the same time, the management server may be responsible for the transfer of virtual currency between a plurality of (such as 10 and 20) devices in actual applications, and therefore, the virtual currency transfer request may further include an identifier of a second device to indicate the management server of the device to which the virtual currency is transferred. In an actual application, the identifier of the second device may be a pre-registered account. When the management server implements the transfer of virtual currency to the second device, the virtual currency may specifically be transferred to the account corresponding to the second device, so that the amount of the virtual currency under the account is increased by the above first amount.

It is worth noting that the first device and the second device in this embodiment refer to devices owned by both parties of a transaction, such as terminals or servers belonging to different enterprises respectively. The device owned by the party paying the virtual currency is the first device, and the device owned by the party receiving the virtual currency is the second device. Moreover, in different transactions, the device of the same enterprise may assume different roles. For example, in a supply chain such as supplier→manufacturer→distributor, when the supplier supplies raw materials for the manufacturer, the manufacturer needs to pay corresponding virtual currency to the supplier. In this case, the device belonging to the manufacturer is the above first device, and the device belonging to the supplier is the above second device. When the manufacturer provides a manufactured product for the distributor, the distributor needs to pay virtual currency to the manufacturer. In this case, the device belonging to the distributor is the above first device, and the device belonging to the manufacturer is the above second device.

In S202, the management server receives and responds to the virtual currency transfer request, and transfers the virtual currency of the first amount belonging to the first device to the second device corresponding to the identifier of the second device, wherein the virtual currency may be used to be exchanged for a legal currency.

After receiving the virtual currency transfer request sent by the first device, the management server may parse out the first amount of virtual currency to be transferred this time and the identifier of the second device from the virtual currency transfer request, and then the management server may divide the virtual currency of the first amount from the virtual currency belonging to the first device and transfer it to the second device corresponding to the identifier of the second device. In an example implementation of a practical application, the management server may take out the virtual currency of the first amount from an account corresponding to the first device, and transfer the virtual currency to an account corresponding to the second device.

In this way, two parties represented by the first device and the second device may use virtual currency to complete delivery in a transaction process, without an actual flow of funds between the first device and the second device, so as to effectively reduce due diligence costs of the funding parties.

Further, before transferring the virtual currency of the first device, the management server may further verify validity of the first device, so as to improve the security of the transfer of the virtual currency of the first device. In a specific implementation, the management server may verify a virtual currency transfer permission of the first device, for example, it may verify whether the first device currently has a valid virtual currency transfer permission by using information such as a specific password or biometric information (e.g. a fingerprint, voice, etc.), if the verification is successful, for example, the password or biometric information matches, the management server may take out the first amount of the virtual currency from the virtual currency belonging to the first device and transfer it to the second device; and if the verification is failed, the management server may refuse to perform this virtual currency transfer operation, and may further send a prompt of verification failure to the first device.

After the virtual currency of the second device is increased, if the second device needs to obtain funds, it may request the management server to exchange the virtual currency for a legal currency (for example, RMB, U.S. dollars, or the like) in actual applications. In an example specific implementation, the second device may generate a virtual currency exchange request, and the virtual currency exchange request includes a second amount of a to-be-exchanged virtual currency. In an actual application, the second amount may be entered by the user into the second device. Then, the management server may respond to the virtual currency exchange request, and exchange the virtual currency of the second amount for corresponding legal currency to the target device. For example, it is specified that a virtual currency may be exchanged for a legal currency, and the like. The target device may specifically be a device capable of providing legal currency support, such as a server of a bank or a server of a financing party. The target device may provide the management server with a corresponding amount of legal currency according to the amount of the virtual currency sent by the management server. In this way, the second device may get required funds at any time according to requirements of an actual application. Moreover, different devices in the entire supply chain may uniformly use the management server to request funds from the target device, and it is unnecessary for each device to directly interact with the target device to request the funds.

Further, after the management server exchanges for a legal currency for the second device, the virtual currency of the second amount, which has been used to be exchanged for the legal currency, in the second device may be destroyed, or the virtual currency is made to no longer have the value of being exchanged for the legal currency. In this way, after the management server exchanges for the legal currency, the virtual currency that can be exchanged for a legal currency by the second device may be reduced. Of course, in a specific implementation, after the amount of a legal currency that the virtual currency can be exchanged for is determined, the virtual currency may be destroyed, and the virtual currency may be destroyed without waiting for completion of the exchange for the legal currency.

Of course, in practical applications, not only can a virtual currency be exchanged for a legal currency, but also a legal currency can be exchanged for a virtual currency, so that the virtual currency may be used to deliver the services or goods provided during a transaction between the two parties. In a specific implementation, the first device (or the second device) may generate a legal currency exchange request and send it to the management server. The legal currency exchange request may include a third amount of a to-be-exchanged legal currency. The management server may parse out, from the received legal currency exchange request, the third amount of the legal currency exchanged for this time, and exchange the virtual currency corresponding to the third amount of the legal currency to the target device. Similarly, the target device may specifically be a device capable of providing legal currency support, such as a server of a bank or a server of a financing party. In the exchange process, the target device may deduct the third amount from the legal currency of the first device (or the second device). After the deduction is completed, the management server may be instructed to allocate a corresponding amount of virtual currency to the first device (or the second device), to achieve the exchange from the legal currency to the virtual currency.

It is worth noting that when the technical solution of this embodiment is applied to a supply chain constructed by a plurality of enterprises, in order to facilitate the inspection of transaction records, transaction data between different enterprises may be stored by using a blockchain technology. Specifically, data uploaded by the first device and/or the second device may be allocated to a target node in a blockchain. For example, each time a supplier provides goods for a manufacturer, a device of the supplier and a device of the manufacturer may upload goods data to the management server respectively, and the management server allocates the goods data to the target node of the corresponding blockchain. At the same time, the management server may further store an amount of the virtual currency transferred during each transaction in the target node. In this way, based on the data stored by each node of the blockchain, open and transparent transaction records between the first device and the second device may be checked.

Further, the management server in this embodiment may be established by a core enterprise in the supply chain, thus increasing the reputation guarantee of the management server. Compared with a conventional supply chain, finance may be fully distributed from a target device to the level of a core enterprise, and the core enterprise may improve financing stability of its upstream and downstream enterprises.

In this embodiment, the management server may receive a virtual currency transfer request from the first device, wherein the virtual currency transfer request may include a first amount of a to-be-transferred virtual currency and an identifier of a second device, and then the management server may transfer, in response to the received virtual currency transfer request, the virtual currency of the first amount belonging to the first device to the second device corresponding to the identifier of the second device. It is worth noting that the transferred virtual currency may be used to be exchanged for a legal currency. As can be seen, in a transaction process, the management server may transfer the virtual currency belonging to the first device to the second device, that is, the delivery is performed based on a virtual currency in the transaction process. In this way, when an enterprise to which a second device in a supply chain belongs needs to obtain funds, a virtual currency belonging to the second device can be exchanged for a legal currency, so that the enterprise can get the required legal currency at any time by means of currency exchange. Moreover, the delivery is performed based on a virtual currency in the transaction process, which does not require capital transfer, and may effectively reduce due diligence costs of the funding parties.

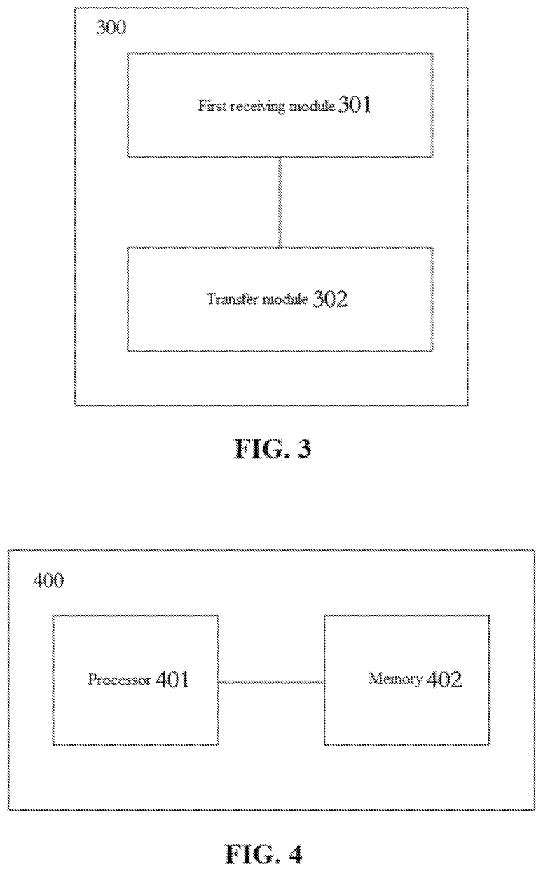

In addition, a transaction apparatus is further provided in the embodiments of this application. Referring to FIG. 3, FIG. 3 is a schematic structural diagram of a transaction apparatus according to an embodiment of this application. Apparatus 300 includes:
a first receiving module 301 configured to receive a virtual currency transfer request from a first device, the virtual currency transfer request including a first amount of a to-be-transferred virtual currency and an identifier of a second device; and
a transfer module 302 configured to transfer, in response to the virtual currency transfer request, the virtual currency of the first amount belonging to the first device to the second device corresponding to the identifier of the second device,
wherein the virtual currency is used to be exchanged for a legal currency.

In some possible implementations, apparatus 300 further includes:
a second receiving module configured to receive a virtual currency exchange request from the second device, the virtual currency exchange request including a second amount of a to-be-exchanged virtual currency; and
a first exchange module configured to exchange for the legal currency corresponding to the virtual currency of the second amount to a target device, wherein the target device is a device that provides legal currency support.

In some possible implementations, apparatus 300 further includes:
a destruction module configured to destroy the virtual currency of the second amount.

In some possible implementations, apparatus 300 further includes:
a third receiving module configured to receive a legal currency exchange request, the legal currency exchange request including a third amount of a to-be-exchanged legal currency; and
a second exchange module configured to exchange for a virtual currency corresponding to the legal currency of the third amount to a target device, wherein the target device is a device that provides legal currency support.

In some possible implementations, transfer module 302 includes:
a verification unit configured to verify a virtual currency transfer permission of the first device; and
a transfer unit configured to transfer, if the virtual currency transfer permission succeeds in the verification, the virtual currency of the first amount belonging to the first device to the second device corresponding to the identifier of the second device.

In some possible implementations, apparatus 300 further includes:
an allocation module configured to allocate data uploaded by the first device and/or the second device to a target node in a blockchain.

It should be noted that the contents such as information exchange and execution processes between the modules and units of the above apparatus are based on the same concept as the method embodiment in the embodiments of this application, and the technical effect brought is the same as that of the method embodiment in the embodiments of this application. The specific contents may be obtained with reference to the description in the method embodiment as described in the embodiments of this application, and the descriptions thereof are omitted herein.

In addition, an embodiment of this application further provides a device. Referring to FIG. 4, FIG. 4 is a schematic diagram of a hardware structure of a device according to an embodiment of this application. Device 400 may include processor 401 and memory 402.

Memory 402 is configured to store a computer program; and
processor 401 is configured to perform the transaction method described in the foregoing method embodiment according to the computer program.

In addition, an embodiment of this application further provides a transaction system. The transaction system may include device 101, device 102, management server 103, and target device 104 as shown in FIG. 1. Device 101 and device 102 may be respectively configured to perform the method operations performed by the first device and the second device described in the above method embodiment. Management server 103 may perform the method operations performed by the management server described in the above method embodiment. Target device 104 may perform the method operations performed by the target device described in the above method embodiment.

The “first” in the names of “first device,” “first receiving module,” “first exchange module,” and the like mentioned in the embodiments of this application is only used as a name identification, and does not represent the first in order. The rule also applies to “second” and so on.

From the description of the foregoing implementations, those skilled in the art can clearly understand that all or part of the steps in the foregoing embodiment methods may be implemented by means of software plus a general hardware platform. Based on such understanding, the technical solutions of this application may be embodied in the form of a software product. The computer software product may be stored in a storage medium, such as a read-only memory (ROM)/RAM, a magnetic disk, or an optical disc, and include several instructions that enable a computer device (which may be a personal computer, a server, or a network communication device such as a router) to perform the method in the embodiments or certain portions of the embodiments of this application.

The embodiments in the specification are described progressively, identical or similar parts of the embodiments may be obtained with reference to each other, and each embodiment focuses on a part different from other embodiments. In particular, the apparatus embodiment is basically similar to the method embodiment, so it is described simply, and related parts can be obtained with reference to the partial description of the method embodiment. The apparatus embodiments described above are merely illustrative. The modules described as separate members may or may not be physically separate, and members displayed as modules may or may not be physical modules, may be located in one position, or maybe distributed on a plurality of network units. Some or all of the modules may be selected according to actual requirements to achieve the objectives of the solutions of the embodiments. Those of ordinary skill in the art can understand and implement the solutions without creative efforts.

The above are only example implementations of this application, and are not intended to limit the protection scope of this application.

1. A transaction method, wherein the method is applied to a management server, and the method comprises:
receiving a virtual currency transfer request from a first device, the virtual currency transfer request comprising a first amount of a to-be-transferred virtual currency and an identifier of a second device; and
transferring, in response to the virtual currency transfer request, the virtual currency of the first amount belonging to the first device to the second device corresponding to the identifier of the second device,
wherein the virtual currency is used to be exchanged for a legal currency.

2. The method of claim 1, wherein the method further comprises:
receiving a virtual currency exchange request from the second device, the virtual currency exchange request comprising a second amount of a to-be-exchanged virtual currency; and
exchanging for the legal currency corresponding to the virtual currency of the second amount to a target device, wherein the target device is a device that provides legal currency support.

3. The method of claim 2, wherein the method further comprises:
destroying the virtual currency of the second amount.

4. The method of claim 1, wherein the method further comprises:
receiving a legal currency exchange request, the legal currency exchange request comprising a third amount of a to-be-exchanged legal currency; and
exchanging for a virtual currency corresponding to the legal currency of the third amount to a target device, wherein the target device is a device that provides legal currency support.

5. The method of claim 1, wherein the transferring the virtual currency of the first amount belonging to the first device to the second device corresponding to the identifier of the second device comprises:
verifying a virtual currency transfer permission of the first device; and
transferring, if the virtual currency transfer permission succeeds in the verification, the virtual currency of the first amount belonging to the first device to the second device corresponding to the identifier of the second device.

6. The method of claim 1, wherein the method further comprises:
allocating data uploaded by the first device and/or the second device to a target node in a blockchain.

7. The method of claim 6, further comprising storing, by the management server and in the target node, the first amount of the virtual currency transferred in accordance with the virtual currency transfer request.

8. A transaction apparatus, wherein the apparatus is applied to a management server, and the apparatus comprises:
a first receiving module configured to receive a virtual currency transfer request from a first device, the virtual currency transfer request comprising a first amount of a to-be-transferred virtual currency and an identifier of a second device; and
a transfer module configured to transfer, in response to the virtual currency transfer request, the virtual currency of the first amount belonging to the first device to the second device corresponding to the identifier of the second device,
wherein the virtual currency is used to be exchanged for a legal currency.

9. The apparatus of claim 8, wherein the apparatus further comprises:
a second receiving module configured to receive a virtual currency exchange request from the second device, the virtual currency exchange request comprising a second amount of a to-be-exchanged virtual currency; and
a first exchange module configured to exchange for the legal currency corresponding to the virtual currency of the second amount to a target device, wherein the target device is a device that provides legal currency support.

10. A device, wherein the device comprises a memory and a processor;
the memory is configured to store a computer program; and
the processor is configured to perform the transaction method of claim 1.

11. A transaction system, wherein the system comprises the first device, the second device, and the management server of claim 1.
